(19) United States
(12) Patent Application Publication
(10) Pub. No.: US 2008/0055505 A1
(43) Pub. Date: Mar. 6, 2008

(54) ESD protection control circuit and LCD

(76) Inventors: Yen-Hsien Yeh, Hsin-Chu (TW); Chun-Ching Wei, Hsin-Chu (TW); Shih-Hsun Lo, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/766,788

(22) Filed: Jun. 21, 2007

(30) Foreign Application Priority Data
Aug. 29, 2006 (TW) 095131762

(51) Int. Cl. H05F 3/00; G02F 1/1333

(52) U.S. Cl. 349/40; 361/220

(57) ABSTRACT

A control circuit equipped with electrostatic discharge (ESD) protection includes a plurality of shift registers, a plurality of buses coupled to the plurality of shift registers, a common line, a set of ESD protection components coupled to a set of the plurality of the buses for protecting the plurality of buses from ESD events; and a set of current paths coupled between the set of the ESD protection components and the common line for providing the ESD current paths to pass through.

### BACKGROUND OF THE INVENTION

1. Field of the Invention

The present invention provides control circuits with ESD protection, and more particularly, control circuits with ESD protection of a LCD.

2. Description of the Prior Art

Please refer to FIG. 1. FIG. 1 is a diagram illustrating a conventional liquid crystal display (LCD) 100. The conventional LCD 100 comprises a first glass substrate 110, a liquid crystal layer 120, and a second glass substrate 130. The first glass substrate 110 comprises a color filter. The second glass substrate 130 comprises thin film transistors.

Please refer to FIG. 2. FIG. 2 is a diagram illustrating the second glass substrate 130. As shown in FIG. 2, the second glass substrate 130 comprises a plurality of gate lines, a plurality of data lines, and a plurality of pixel areas, such as the pixel area 210, formed by the gate lines interwoven with the data lines. For example, the pixel area 210 comprises a thin film transistor Q1 and a storage capacitor C1. The gate of the thin film transistor Q1 is coupled to the adjacent gate line, the source of the thin film transistor Q1 is coupled to the adjacent data line, and the drain of the thin film transistor Q1 is coupled to the storage capacitor C1. One end of the storage capacitor C1 is coupled to the drain of the thin film transistor Q1 and the other end of the storage capacitor C1 is coupled to a common line VCOM. All the storage capacitors of the pixel areas have one end conjointly coupled to the common line VCOM for storing voltages based on the same voltage level.

Please refer to FIG. 3. FIG. 3 is a diagram illustrating a glass substrate 330 with electrostatic discharge (ESD) protection. Because the gate lines and the data lines of the glass substrate 330 are coupled to the margin of the glass substrate 330 for receiving gate signals and source signals from external devices, ESD events easily happen and break the internal thin film transistors. Therefore, ESD protection components are disposed at the margin of the glass substrate 330. As shown in FIG. 3, The ESD protection component E1 is coupled to the first gate line, the ESD protection component E2 is coupled to the second gate line, and so on. Each of the ESD protection components have one end coupled to a common line VA which is known as a short ring. In this way, ESD currents are dispersed and the internal thin film transistors are protected.

However, another kind of glass substrate is not completely protected from ESD events by the method described above. Please refer to FIG. 4. FIG. 4 is a diagram illustrating a glass substrate 400. The glass substrate 400 comprises a pixel module 410, a shift register 420, and a bus module 430. The pixel module 410 comprises a plurality of pixel areas and an ESD protection module 412. The pixel module 410 is designed similarly to FIG. 2 and FIG. 3, which is also constructed of a plurality of pixel areas such as the pixel area 411 formed by the gate lines interwoven with the data lines. The ESD protection module 412 comprises a plurality of ESD protection components E5 to En, and a common line VA. The shift register module 420 comprises a plurality of shift registers S1 to Sn. Each shift register is coupled to a corresponding gate line.

The first shift register S1 receives a start signal ST for transmitting a first gate driving signal to the first gate line after a predetermined period, the second shift register S1 receives the first gate driving signal for transmitting a second gate driving signal to the second gate line after the predetermined period, and so on. The scanning of a frame is achieved by sequentially driving the n gate lines of the LCD. The bus module 430 comprises buses B1, B2, and B3 for respectively providing a voltage VSS, a clock signal XCK, and a clock signal CK to the shift register module 420. The difference between the glass substrates 130 and 400 is that the glass substrate 400 has the shift register module 420 and the bus module 430, but there is no ESD protection component designed for shift register module 420 and the bus module 430. Besides, because the bus module 430 receives the voltage VSS, the clock signals XCK and CK from external devices, the bus module 430 also has to be coupled to the margin of the glass substrate 400, which is easier to be affected or broken by an ESD event. Thus, when producing the glass substrate 400, it easily fails and thereby lowers the yield rate.

### SUMMARY OF THE INVENTION

The present invention provides a control circuit with electrostatic discharge protection. The control circuit comprises a plurality of shift registers; a plurality of buses coupled to the plurality of shift registers; a common line; a set of electrostatic discharge protection components coupled to a set of buses of the plurality of the buses for protecting the plurality of the buses from electrostatic discharge events; and a set of dispersion paths coupled to the set of the electrostatic discharge protection components and the common line for providing dispersion paths to currents of the electrostatic discharge events.

The present invention further provides a liquid crystal display having control circuits with electrostatic discharge protection. The liquid crystal display comprises a first glass substrate comprising a plurality of control circuits; a plurality of buses coupled to the plurality of the control circuits; a common line; a set of electrostatic discharge protection components coupled to a set of buses of the plurality of the buses for protecting the plurality of the buses from electrostatic discharge events; and a set of dispersion paths coupled to the set of the electrostatic discharge protection components and the common line for providing dispersion paths to currents of the electrostatic discharge events; a second glass substrate; and a liquid crystal layer disposed between the first glass substrate and the second glass substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional liquid crystal display.

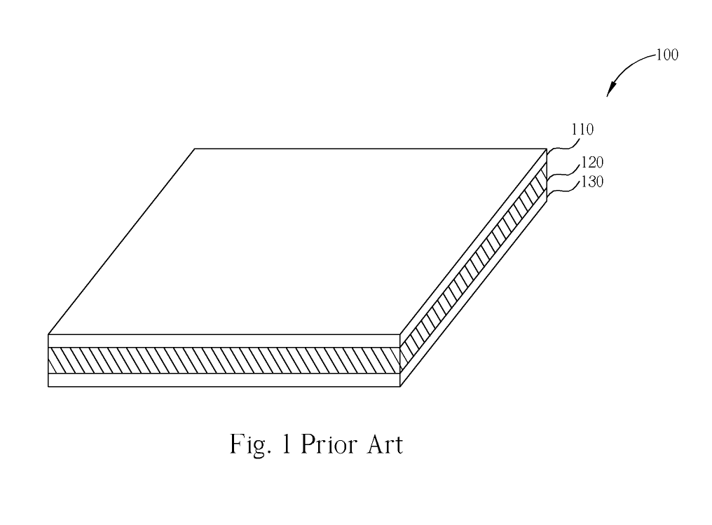

FIG. 2 is a diagram illustrating the second glass substrate.

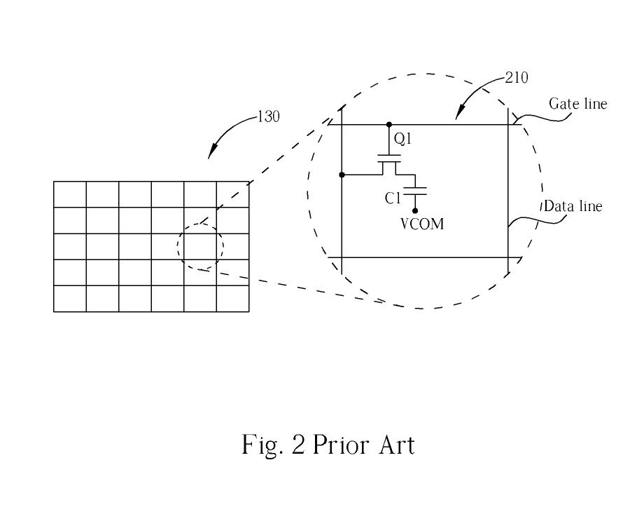

FIG. 3 is a diagram illustrating a glass substrate with electrostatic discharge protection.

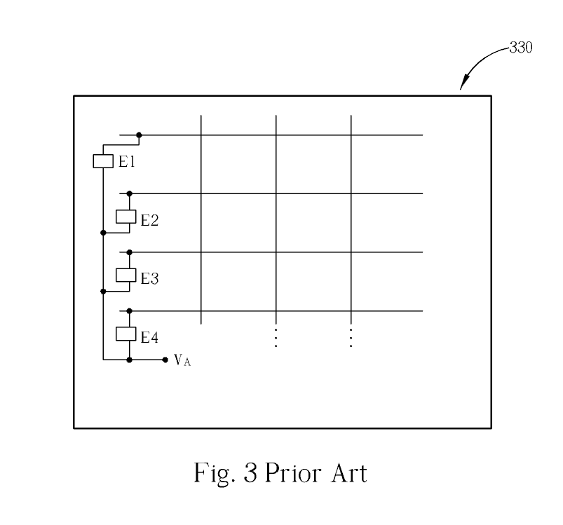

FIG. 4 is a diagram illustrating a glass substrate.

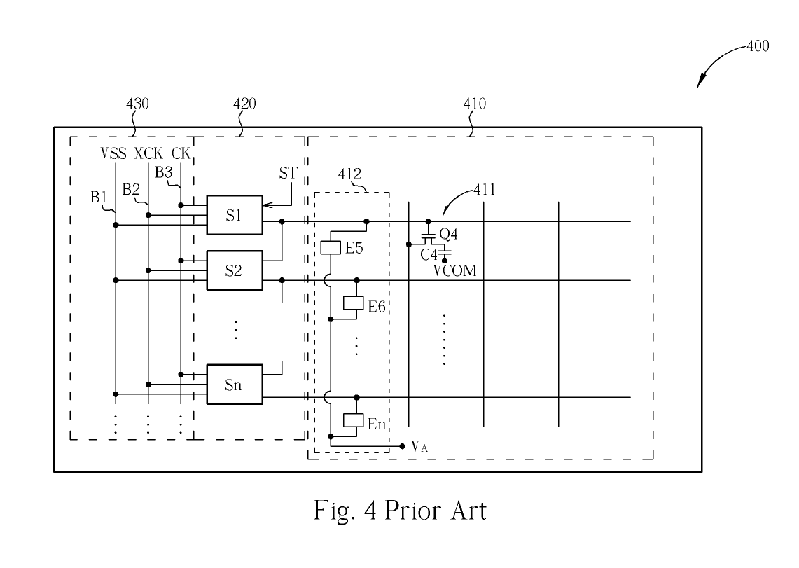

FIG. 5 is a diagram illustrating a control circuit with ESD protection of the present invention.

FIG. 6 is a glass substrate with ESD protection of the present invention.

FIG. 7 is a diagram illustrating a control circuit of another embodiment of the present invention.

FIG. 8 is a glass substrate with ESD protection of another embodiment of the present invention.

FIG. 9 is a diagram illustrating the ESD protection component of the present invention.

### DETAILED DESCRIPTION

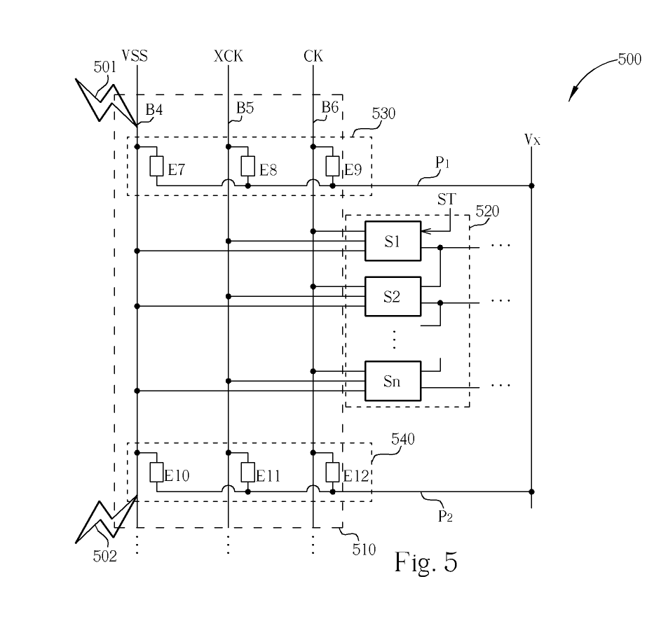

Please refer to FIG. 5. FIG. 5 is a diagram illustrating a control circuit 500 with ESD protection of the present invention. As shown in FIG. 5, the control circuit 500 comprises a bus module 510, a shift register module 520, two ESD protection modules 530 and 540, two dispersion paths P1 and P2, and a common line Vx. The bus module 510 comprises buses B4, B5, and B6 for respectively providing a voltage VSS, clock signals XCK and CK to the shift register module 520. The shift register module 520 comprises a plurality of shift registers S1 to Sn. Each shift register is coupled to a corresponding gate line. The first shift register S1 receives a start signal ST for transmitting a first gate driving signal to the first gate line after a predetermined period, the second shift register S2 receives the first gate driving signal for transmitting a second gate driving signal to the second gate line after the predetermined period, and so on. The scanning of a frame is achieved by sequentially driving the n gate lines of the LCD. The ESD protection module 530 comprises three ESD protection components E7, E8, and E9 respectively coupled to the buses B4, B5, and B6 for protecting the buses B4 to B6 from ESD events. The ESD protection module 540 comprises three ESD protection components E10, E11, and E12 respectively coupled to the buses B4, B5, and B6 for protecting the buses B4 to B6 from ESD events. The ESD protection modules 530 and 540 are positioned at a distance from each other. The dispersion paths P1 and P2 are respectively coupled the ESD protection modules 530 and 540 for providing dispersion paths to the ESD currents. The common line Vx is coupled to the dispersion paths P1 and P2 for dispersing the ESD currents. For example, in a normal condition, the ESD protection module 530 is open. Therefore, with regards to the bus B4, the ESD protection component E7 is open so that the operation of the bus B4 is not interfered with. When an ESD event 501 happens at the upper part of the bus B4, the ESD protection component E7 conducts the ESD current to the dispersion path P1 so that the ESD current can be dispersed through the common line Vx. Thus, the bus B4 is protected from the ESD event. When an ESD event 502 happens at the lower part of the bus B4, the ESD protection component E10 conducts the ESD current to the dispersion path P2 so that the ESD current can be dispersed through the common line Vx. Thus, the bus B4 is again protected from the ESD event. Actually the positions of the ESD modules 530 and 540 are not limited to the upper or the lower parts of the buses. The related layout design is also to be considered when positioning the ESD modules 530 and 540. Besides, the amount of the ESD protection modules can be more than 2 if needed.

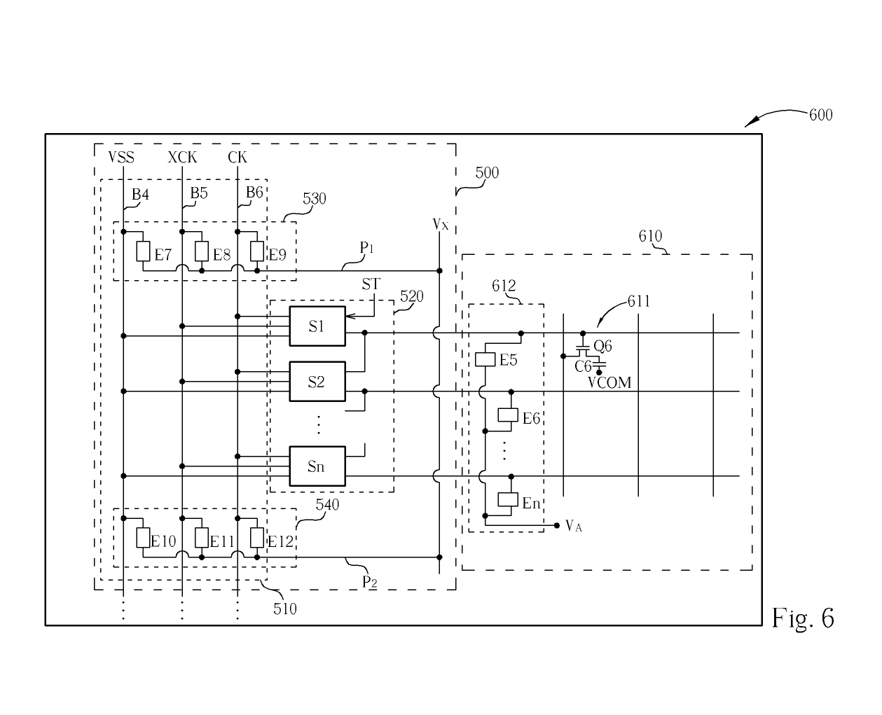

Please refer to FIG. 6. FIG. 6 is a glass substrate 600 with ESD protection of the present invention. The glass substrate 600 comprises a pixel module 610 and a control circuit 500. The pixel module 610 comprises a plurality of pixel areas and an ESD protection module 612. The pixel module 610 is the same as the pixel module 410 as the pixel area 611 shown in FIG. 6. The ESD protection module 612 comprises a plurality of ESD protection components E13 to En, and a common line VA. The common line Vx of the control circuit 500 can couple to the common line VCOM of the pixel module 610 or the common line VA of the ESD protection module 612. Consequently when the ESD event happens at the bus module 510, the ESD current can pass to the common lines VCOM or VA for being dispersed through the ESD protection module 530 or 540, the dispersion paths P1 or P2, and the common line Vx. Therefore, the bus module 510 is protected from the ESD event.

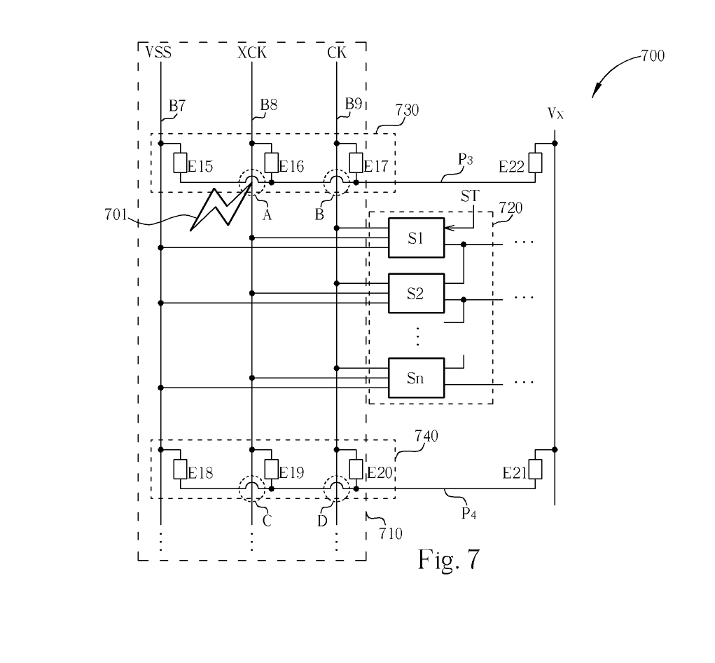

Please refer to FIG. 7. FIG. 7 is a diagram illustrating a control circuit 700 of another embodiment of the present invention. As shown in FIG. 7, the control circuit 700 comprises a bus module 710, a shift register module 720, two ESD protection modules 730 and 740, two ESD protection components E21 and E22, two dispersion paths P3 and P4, and a common line Vx. The bus module 710 comprises three buses B7, B8, and B9 for respectively providing a voltage VSS, clock signals XCK and CK to the shift register module 720. The shift register module 720 comprises a plurality of shift registers S1 to Sn. Each shift register is coupled to a corresponding gate line. The first shift register S1 receives a start signal ST for transmitting a first gate driving signal to the first gate line after a predetermined period, the second shift register S2 receives the first gate driving signal for transmitting a second gate driving signal to the second gate line after the predetermined period, and so on. The scanning of a frame is achieved by sequentially driving the n gate lines of the LCD. The ESD protection module 730 comprises three ESD protection components E15, E16, and E17 respectively coupled to the upper parts of the buses B7, B8, and B9 for protecting the buses B7 to B9 from ESD events. The ESD protection module 740 comprises three ESD protection components E18, E19, and E20 respectively coupled to lower parts of the buses B4, B5, and B6 for protecting the buses B7 to B9 from ESD events. The dispersion paths P3 and P4 are respectively coupled the ESD protection modules 730 and 740 for providing dispersion paths to the ESD currents. The common line Vx is coupled to the dispersion paths P3 and P4 through the ESD protection components E22 and E21 respectively for dispersing the ESD currents. The control circuit 700 is the same as the control circuit 500 except the control circuit 700 further comprises two ESD protection components E21 and E22 respectively coupled between the dispersion paths P3, P4 and the common line Vx. The ESD components E21 and E22 are designed for preventing the dispersion paths P3 or P4 from shorting with the buses B7, B8, and B9. For example, when an ESD event 701 happens at the area A and punches through the area A, the dispersion path P3 shorts with the bus B8. If the dispersion path P3 shorts with the bus B8, because the common line Vx provides a fixed voltage level, the clock signal XCK on the bus B8 is pulled by the fixed voltage level, causing the control circuit 700 to operate incorrectly. Therefore, the ESD protection component E21 is disposed between the dispersion path P3 and the common line Vx to prevent the bus B8 from being directly coupled to the common line Vx. Besides, in the normal condition, the ESD protection component E21 is open so the bus B9 operates regularly. For example, in the normal condition, the ESD protection module 530 is open. It is also the same when the ESD event 701 happens at the areas B, C, and D. The ESD protection components E21 and E22 also prevent the buses B7 to B9 from directly coupling to the common line Vx. On the other hand, the areas A to D only represent the dispersion paths disposed across the buses, not coupled to the buses. For example, the bus B8 is disposed vertically in the first layer and the dispersion path P3 is disposed horizontally in the second layer. Therefore, in the normal condition, the first layer and the second layer are isolated so the bus B8 is not coupled to the dispersion path P3. But when the ESD event 701 happens at the area A and punches through the area A, the bus B8 of the first layer shorts with the dispersion path P3 of the second layer. Actually the positions of the ESD modules 730 and 740 are not limited to the upper or the lower parts of the buses. The related layout design is also to be considered when positioning the ESD modules 730 and 740. Besides, the amount of the ESD protection modules can be more than 2 if needed.

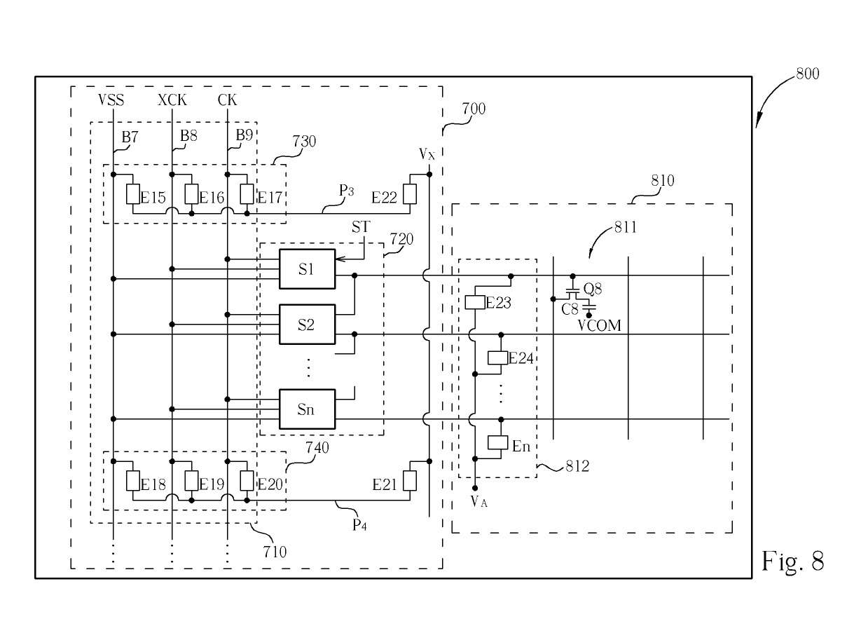

Please refer to FIG. 8. FIG. 8 is a glass substrate 800 with ESD protection of another embodiment of the present invention. The glass substrate 800 comprises a pixel module 810 and a control circuit 700. The pixel module 810 comprises a plurality of pixel areas and an ESD protection module 812. The pixel module 810 is the same as the pixel module 410 as the pixel area 811 shown in FIG. 6. The ESD protection module 812 comprises a plurality of ESD protection components E23 to En, and a common line VA. The common line Vx of the control circuit 700 can couple to the common line VCOM of the pixel module 810 or the common line VA of the ESD protection module 812. Consequently when the ESD event happens at the bus module 710, the ESD current can pass to the common lines VCOM or VA for being dispersed through the ESD protection module 730 or 740, the dispersion paths P3 or P4, and the common line Vx. Therefore, the bus module 710 is protected from the ESD event.

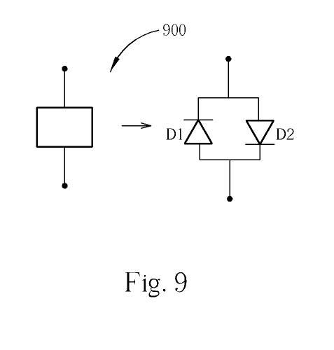

Please refer to FIG. 9. FIG. 9 is a diagram illustrating the ESD protection component 900 of the present invention. The ESD protection component 900 can comprise a diode D1 reversely parallel coupled to a diode D2, or any other component having the ESD protection function.

To sum up, with the present invention, during production, the glass substrate is effectively protected from ESD events so that the circuits and the buses on the glass substrate are not broken by the ESD events. Thus the yield rate of the production is improved. Additionally, the design of the ESD protection of the present invention is not limited to the glass substrate and the LCD. Any other designs using ESD components, dispersion paths, and common lines are included in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit with electrostatic discharge (ESD) protection comprising:
a plurality of shift registers;
a plurality of buses coupled to the plurality of shift registers;
a common line;
a set of electrostatic discharge protection components coupled to a set of buses of the plurality of the buses for protecting the plurality of the buses from electrostatic discharge events; and
a set of dispersion paths coupled to the set of the electrostatic discharge protection components and the common line for providing dispersion paths to currents of the electrostatic discharge events.

2. The control circuit of claim 1 wherein the set of the electrostatic discharge protection components comprises a first electrostatic discharge protection component coupled to a first bus of the plurality of the buses; the set of the dispersion paths comprising a first dispersion path coupled to the first electrostatic discharge protection component and the common line.

3. The control circuit of claim 2 further comprises a second electrostatic discharge protection component coupled to the first dispersion path and the common line.

4. The control circuit of claim 2 wherein the set of the electrostatic discharge protection components further comprises a second electrostatic discharge protection component coupled to the first bus of the plurality of the buses; the set of the dispersion paths further comprising a second dispersion path coupled to the second electrostatic discharge protection component and the common line.

5. The control circuit of claim 4 further comprises a third electrostatic discharge protection component coupled to the second dispersion path and the common line.

6. The control circuit of claim 1 wherein the set of the electrostatic discharge protection components comprises a plurality of first electrostatic discharge protection components coupled to the plurality of the buses; the set of the dispersion paths comprising a first dispersion path coupled to plurality of the first electrostatic discharge protection components and the common line.

7. The control circuit of claim 6 further comprising a second electrostatic discharge protection component coupled between the first dispersion path and the common line.

8. The control circuit of claim 6 wherein the set of the electrostatic discharge protection components further comprises a plurality of second electrostatic discharge protection components coupled to the plurality of the buses; the set of the dispersion paths further comprising a second dispersion path coupled to the plurality of the second electrostatic discharge components and the common line.

9. The control circuit of claim 8 further comprising a third electrostatic discharge protection component coupled between the second dispersion path and the common line.

10. The control circuit of claim 1 wherein one electrostatic discharge protection component of the set of the electrostatic discharge protection components comprises a first diode reversely parallel coupled to a second diode.

11. A liquid crystal display (LCD) having control circuits with electrostatic discharge protection comprising:
a first glass substrate comprising:
a plurality of control circuits;
a plurality of buses coupled to the plurality of the control circuits;
a common line;
a set of electrostatic discharge protection components coupled to a set of buses of the plurality of the buses for protecting the plurality of the buses from electrostatic discharge events; and
a set of dispersion paths coupled to the set of the electrostatic discharge protection components and the common line for providing dispersion paths to currents of the electrostatic discharge events;
a second glass substrate; and
a liquid crystal layer disposed between the first glass substrate and the second glass substrate.

12. The liquid crystal display of claim 11 wherein the set of the electrostatic discharge protection components comprises a first electrostatic discharge protection component coupled to a first bus of the plurality of the buses; the set of the dispersion paths comprising a first dispersion path coupled to the first electrostatic discharge protection component and the common line.

13. The liquid crystal display of claim 12 wherein the first glass substrate further comprises a second electrostatic discharge protection component coupled to the first dispersion path and the common line.

14. The liquid crystal display of claim 12 wherein the set of the electrostatic discharge protection components further comprises a second electrostatic discharge protection component coupled to the first bus of the plurality of the buses; the set of the dispersion paths further comprising a second dispersion path coupled to the second electrostatic discharge protection component and the common line.

15. The liquid crystal display of claim 14 wherein the first glass substrate further comprises a third electrostatic discharge protection component coupled to the second dispersion path and the common line.

16. The liquid crystal display of claim 11 wherein the set of the electrostatic discharge protection components comprises a plurality of first electrostatic discharge protection components coupled to the plurality of the buses; the set of the dispersion paths comprising a first dispersion path coupled to plurality of the first electrostatic discharge protection components and the common line.

17. The liquid crystal display of claim 16 wherein the first glass substrate further comprises a second electrostatic discharge protection component coupled between the first dispersion path and the common line.

18. The liquid crystal display of claim 16 wherein the set of the electrostatic discharge protection components further comprises a plurality of second electrostatic discharge protection components coupled to the plurality of the buses; the set of the dispersion paths further comprising a second dispersion path coupled to the plurality of the second electrostatic discharge components and the common line.

19. The liquid crystal display of claim 18 wherein the first glass substrate further comprises a third electrostatic discharge protection component coupled between the second dispersion path and the common line.

20. The liquid crystal display of claim 11 wherein the plurality of the control circuits are a plurality of shift registers.

21. The liquid crystal display of claim 11 wherein one electrostatic discharge protection component of the set of the electrostatic discharge protection components comprises a first diode reversely parallel coupled to a second diode.
